(19) United States
(12) Patent Application Publication
(10) Pub. No.: US 2020/0099640 A1
(43) Pub. Date: Mar. 26, 2020

(54) ONLINE USER MONITORING

(71) Applicant: SPIRIT AI LIMITED, London (GB)

(72) Inventors: STEVEN WAYNE ANDRE, LONDON (GB); JONATHAN DE FERRARS GREEN, LONDON (GB)

(73) Assignee: SPIRIT AI LIMITED, London (GB)

(21) Appl. No.: 16/618,450

(22) PCT Filed: Jun. 1, 2018
(86) PCT No.: PCT/GB2018/051505

§ 371 Date: Dec. 2, 2019

(30) Foreign Application Priority Data
Jun. 1, 2017 (GB) 1708696.8

(51) Int. Cl. H04L 12/58; H04L 29/08

(52) U.S. Cl. CPC H04L 51/12; H04L 51/04; H04L 67/22

(57) ABSTRACT

A rule is applied to a user action in an online environment to produce a result. The user action is by a second user and a first user is subject to the user action, or the user action is by the first user in response to a prior action by the second user. Based on the result of the applying indicating to do so, a score is determined (502-514) based at least: a first value corresponding to the rule, and a second value based on past actions in the online environment between the first user and the second user using action information relating to the second user stored in an action log of the first user. It is then determined (516) if an intervention action against the second user is to be taken based at least on the score. The intervention action may then be taken (518).

### FIELD OF THE INVENTION

The invention relates to a method of determining if an intervention action is to be taken based on a determined score. The invention also relates to a related apparatus and computer program product.

### BACKGROUND

Real-time online conversations in environments where users may be unknown and/or known to one another, such as in some in-game chatrooms and during live chat in game play, are often unmonitored. Where the conversations are not monitored, no action can be taken against unacceptable online behaviour. Where such conversations are monitored, the monitoring may be by human moderators. In this case, where the number of users is high, only a sample of conversations are typically monitored since monitoring of all conversations would require a large number of moderators and high associated costs. In particular, in some online games very large numbers of users play simultaneously making effective monitoring by human moderators impractical. Also, even where conversations are monitored, typically time elapses between when unacceptable online behaviour has occurred and when a human moderator may detect the unacceptable behaviour. Unacceptable online behaviour may only come to the attention of a human moderator if a user reports the behaviour. Users may not report such behaviour.

Attempts have been made to automate monitoring systems. Known automated monitoring systems have focussed on detecting communications made by users that breach rules that are configured to detect keywords. Where this occurs, such monitoring systems may be configured to notify a human administrator. Such communications may be statements comprising racist language, swear words, or be sexual in nature, for example. It is an object of the present invention to improve upon known monitoring systems.

### SUMMARY OF THE INVENTION

In accordance with a first aspect of the present invention, there is provided a method comprising: applying, at a processing means, a rule to a user action in an online environment to produce a result, wherein the user action is by a second user and a first user is subject to the user action, or the user action is by the first user in response to a prior action by the second user; based on the result of the applying: determining a first value corresponding to the rule; determining a second value based on past actions in the online environment between the first user and the second user using action information relating to the second user stored in an action log of the first user; determining a score based at least on first and second values; determining if at least one intervention action is to be taken against the second user based at least on the score.

Thus, unacceptable user actions, such as linguistic or non-linguistic communications, may be detected by applying rules. The method enables determining of whether an intervention action is to be taken based on a value deriving from the first user—not only based on linguistic communication of the second user as may be done conventionally. Use of multiple values in determining a score that are dependent on different factors enables a monitoring and intervention system that can be configured to respond appropriately in different scenarios. In particular, determining whether or not to take an intervention action based on past actions between the first and second users is useful. For example, offensive language may be acceptable between users who know each other well, but unacceptable between users who are new to each other. The method also enables intervention action to be taken against the second user in real-time.

The actions log of the first user may be stored in a memory means at a user device of the first user or in a memory means at a server means.

Each of the other users and the first user may have a respective avatar and the plurality of actions that precede the first action may be interactions, for example communications, between the avatars.

Other optional and/or preferred features/steps are set out in the dependent claims.

In accordance with a second aspect of the present invention, there is provided a non-transient computer readable medium containing program code which, when executed by a processing means, performs steps of: applying, at a processing means, a rule to a user action in an online environment to produce a result, wherein the user action is by a second user and a first user is subject to the user action, or the user action is by the first user in response to a prior action by the second user; based on the result of the applying: determining a first value corresponding to the rule; determining a second value based on past actions in the online environment between the first user and the second user using action information relating to the second user stored in an action log of the first user; determining a score based at least on first and second values; determining if at least one intervention action is to be taken against the second user based at least on the score.

In accordance with a third aspect of the present invention, there is provided apparatus comprising processing means and memory means having a computer program code stored thereon, wherein the processing means, together with the memory means and the computer program code, are configured to: apply, at a processing means, a rule to a user action in an online environment to produce a result, wherein the user action is by a second user and a first user is subject to the user action, or the user action is by the first user in response to a prior action by the second user; based on the result of the applying: determine a first value corresponding to the rule, determine a second value based on past actions in the online environment between the first user and the second user using action information relating to the second user stored in an action log of the first user, determine a score based at least on first and second values; determine if at least one intervention action is to be taken based at least on the score against the second user.

### BRIEF DESCRIPTION OF THE FIGURES

Embodiments of the invention will now be described, by way of example only, with reference to the accompanying Figures in which:

FIG. 1 shows illustratively a system with which embodiments may be implemented;

FIG. 2 shows illustratively software components in accordance with embodiments;

FIG. 3 shows illustratively that various values are processed to generate a score;

FIG. 4A is a flowchart indicating steps that may occur in determining a real-time comfort value;

FIG. 4B is a flowchart indicating steps that may occur in determining a relationship value;

FIG. 4C is a flowchart indicating steps that may occur in determining a history based value for the second user;

FIG. 5 is a flow diagram indicating steps that may occur in accordance with embodiments when behaviour by one user that may be unacceptable to another user is detected;

FIG. 6A is a table indicating correspondence between categories and category values, in accordance with an embodiment;

FIG. 6B is a table indicating correspondence between rules and rule values, in accordance with another embodiment; and

FIG. 7 is a flow diagram indicating steps involved in identifying a second user.

### DETAILED DESCRIPTION OF EMBODIMENTS

Embodiments of the present invention relate to a monitoring system for use in an online environment enabling interaction between users. The monitoring system is configured to detect activity that may be unwanted by a user and/or may be unacceptable for other users, for example is against the law, and/or is otherwise in violation of terms of use of the online environment. Such unwanted and/or unacceptable activity is referred to herein as “objectionable” activity or action. The monitoring system is also configured to effect intervention action when appropriate.

The system is configured to apply rules to actions by users in the online environment. In response to a result of the applying one of the rules to an action indicating that the action may be objectionable, the monitoring system is configured to determine a score. Depending on the score, an intervention action is then taken, or no intervention action may be taken.

“Breach” of a rule is referred to herein. However, it will be understood that rules can be configured to trigger a result indicating that an objectionable action has taken place when the rule is met rather than when the rule is breached and the difference can be considered semantic. Also, a result of applying a rule may be non-binary, for example may be a value from zero to “1”. In this case, the process of determining the score may be triggered based on a comparison of the result against a predetermined threshold. Thus, no limitation is to be understood from reference to breach of rules. Also, the non-binary result can be used in determining the score.

The term “first user” is used herein to refer to a one of the users who is exposed or subject to an objectionable action. The term “second user” is used to refer to another one of the users who performs an objectionable action. As will be appreciated, any user using the online environment and subject to monitoring by the monitoring system may be a first user or a second user.

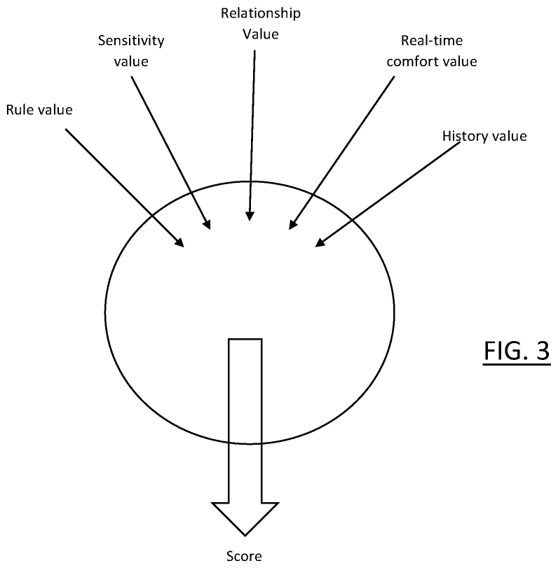

The score is determined based on a plurality of values, as indicated in FIG. 3. One of these values, referred to as a “rule value” corresponds to one or more rules. A rule may be configured with a respective rule value, or alternatively a category to which one or more rules are assigned may have a rule value assigned thereto, and thus all rules assigned to the category have the rule value assigned to the category. This enables the particular rule or category to influence the score, which is highly desirable since breach of one rule or rule in one category is not necessarily as problematic for users and for an administrator of the online environment as breach of another rule or rule in another category.

Another of these values, referred to herein as a “relationship value”, derives from the particular users. Often acceptability of an action performed by the second user to which the first user is subject or exposed is dependent on a relationship between the first user and the second user. For example, where the first and second users have known each other a long time and perhaps are well known to each other offline, any form of offensive language by the second user may be acceptable to the first user, such that the first user would not want intervention action to be taken against the second user and none should be taken. Conversely, if there is no prior relationship and a second user uses offensive language in communication with a first user, the first user may want an intervention action to be taken. Thus, such a user-derived value may be dependent on the particular first and second users. The relationship value can be based on the number of occasions (e.g. sessions) on which the first and second users have interacted and the time period over which those occasions have occurred, for example. The relationship value may be otherwise determined based on a history between the first and second users.

A further user-derived value, referred to herein as a “sensitivity value”, is configurable by the first user to reflect a desired sensitivity level of the monitoring system for that first user. This enables the monitoring system to take into consideration when determining the score a sensitivity level wanted by the first user.

Another user-derived value, referring to herein as a “real-time comfort value”, is determined by causing a question to be posed to the first user, after a rule is breached, and then the value determined based on a response. For example, the question may be simply to ask the first user if he/she is okay.

Another value is determined based on the history of the second user.

Embodiments of the monitoring system are not limited to using the values mentioned above in determining the score. Others may be used instead. Embodiments of the monitoring system also do not have to use all of the values mentioned above in determining the score, but may use one or more of the above-mentioned values.

Embodiments of the invention are not limited to use in any particular kind of online environment, other than that the online environment enables actions by users and an action by one of the users may be objectionable. The online environment may be a chat room allowing conversation in writing between multiple users. The online environment may be a virtual reality environment, which is a simulated environment in which users may interact with virtual objects and locations. In such a virtual reality environment users may move from one location to another. The users may each have a respective avatar and interact with each other using the avatars. The interaction may comprise linguistic communication, touch, performance of financial transactions, giving of a gift, for example. A location may be a simulated room in which avatars of many users are present. The online environment may also be an augmented reality environment.

Objectionable actions may be in the form of offensive or inappropriate linguistic communication. Such communication uses written text or symbols, where communication using written text or symbols is enabled by the online environment. Where the online environment enables speech communication, linguistic communication may also include verbal, speech communication. In order for the communication to be monitored, speech communication is converted to text by a speech-to-text conversion module. Typically, speech by each user is converted to text using a speech-to-text conversion module located at the user device of the respective user.

Objectionable actions do not necessarily only take place in the form of linguistic communication. In some online environments, objectionable non-linguistic actions may occur, for example non-verbal bullying. For example one user may repeatedly target another user, such as by repeatedly shooting them, in a gaming environment. Also, one user may stalk another user in some environments. In some virtual reality environments, non-linguistic unwanted sexual behaviour, such as groping, or other touching may occur. Some virtual reality environments may enable a user to perform rude gestures to other users. Non-linguistic actions include any action that one user can perform to which another user can be exposed or subjected that does not include linguistic communication and is not perceived by the other user in text or spoken form, and is not message based.

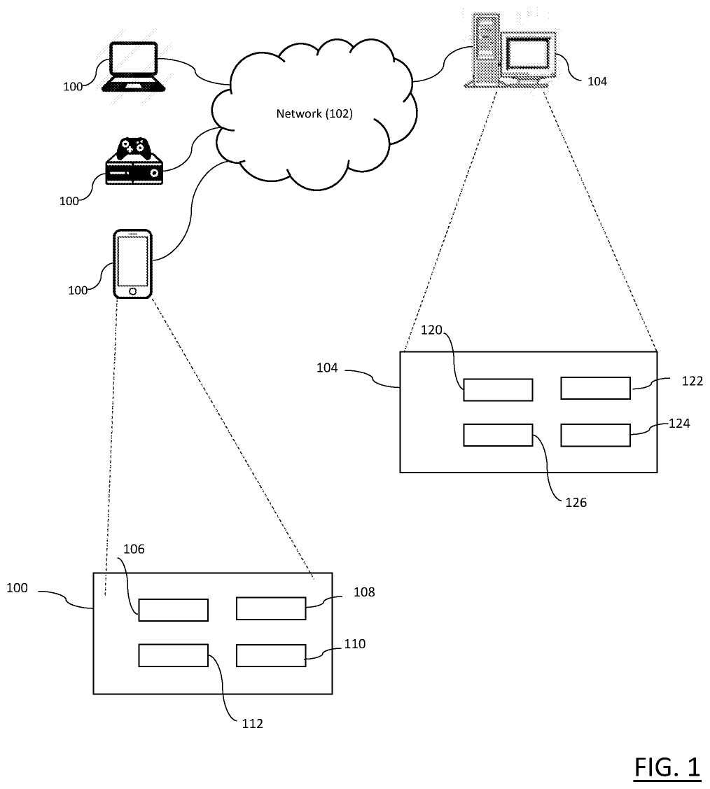

An embodiment will now be described with reference to FIG. 1, in which a plurality of user devices 100 are configured for communication via one or more communications networks 102 such as the Internet. There may be many more such user devices in practice than are indicated. A server unit 104 is connected for communication with the user devices 100 via the one or communications networks 102.

Each user device 100 may be any device capable of the functionality described herein, and in particular may be a suitably configured personal computer, laptop, a video game console, a mobile communications device such as a mobile phone or a tablet, a virtual reality headset, for example. Each user device 100 comprises a first processing unit 106, a first memory unit 108, an input/output unit 110, and a communications unit 112, all operatively connected. As will be understood by the skilled person, each user device 100 would in practice include more hardware components.

The input/output unit 110 is configured to receive user input and provide user output, and may include any hardware, software or firmware supportive of input and output capabilities. For example, the input/output unit 110 may comprise, but is not limited to, a display, keyboard, mouse, keypad, microphone, and touch screen component. Each user device 100 is operable using the input/output unit 110 to perform actions in the online environment. The input/output unit 110 may include one or more components for presenting data and/or content for experiencing by the user, including, but not limited to, a graphics engine, a display, display drivers, one or more audio speakers, and one or more audio drivers.

The communications unit 112 is configured to send data to and receive data from other users devices and from the server unit 104 using the communications network 102. For example, the communications network 102 may include a local area network connected to the internet, and in this case the communications unit 112 includes transmitting and receiving units configured to communicate using Wi-Fi with an access point of the local area network.

Computer programs comprising computer program code are provided stored on the first memory unit 108. The computer programs, when run on the processing unit 106, are configured to provide the functionality ascribed to the respective user device 100 herein. The computer programs may include, for example, a gaming application, or a web browser that may be used to access a chat room, a first monitoring module, as well as an operating system.

Where speech communication between users is to be monitored, each input/output device 110 includes a microphone and speaker. Such communications are converted to text using a speech-to-text conversion module and the communications in text form are then logged for monitoring.

The server unit 104 comprises a second processing unit 120, for example a CPU, a second memory unit 122, a network interface 124, and input/output ports 126, all operatively connected by a system bus (not shown).

The first and/or second memory units 108,122 each comprise one or more data storage media, which may be of any type or form, and may comprise a combination of storage media. Such data storage media may comprise, but are not limited to, volatile and/or non-volatile memory, removable and/or non-removable media configured for storage of information, such as a hard drive, RAM, DRAM, ROM, Erasable Programmable Read Only Memory (EPROM), Electrically Erasable Programmable Read Only Memory (EEPROM), flash memory or other solid state memory, CD-ROM, DVD, or other optical storage, magnetic disk storage, magnetic tape or other magnetic storage devices, or any other medium which can be used to store information in an accessible manner.

The first and/or second processing units 106, 120 may each comprise a plurality of linked processors. The first and/or second memory units 108, 122 may each comprise a plurality of linked memories.

Computer programs comprising computer program code are stored on the second memory 122. The computer programs, when run on the processing units 120, are configured to provide the functionality ascribed to the server unit 104 herein. Such computer programs include an operating system, a second monitoring module, for example. As would be understood by the skilled person, the server unit 104 may in practice include many more hardware and software components.

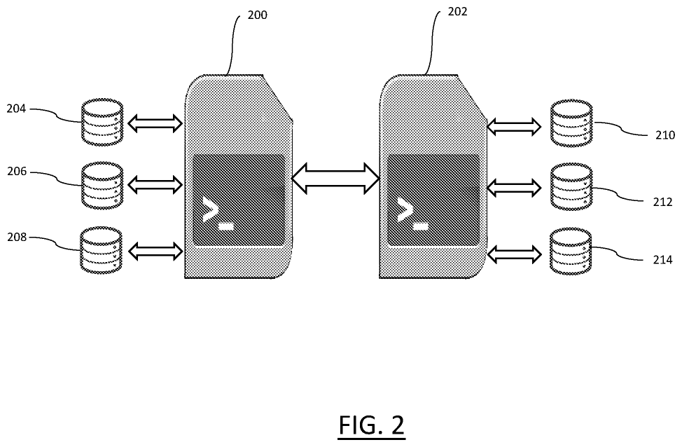

Referring to FIG. 2, a monitoring engine is provided comprising the first monitoring module 200 located in the first memory 108 on each user device 100 and the second monitoring module 202 located on the second memory 122 in the server unit 104. A first actions log 204, a first rules store 206 and a first user data store 208 are located on each user device 100. A second actions log 210, a second rules store 212 and a second user data store 214 are located on the server unit 104.

The first and second actions logs 204, 210 store information indicative of actions to which the user of the user device 100 on which the respective first actions log 204 is located is exposed or subject, and actions performed by that user, such that the rules can be applied to detect objectionable actions. The information indicative of each action stored in the first and second actions log 204, 210 is referred to herein as “action information”. Each action information has an identifier of the user who performed the corresponding action associated with it. Each action information also has a respective time stamp, indicating when the corresponding action took place. References herein to applying rules to an action should be understood as meaning that rules are applied using the action information corresponding to the action.

Where an action is a linguistic communication, the corresponding action information is the communication. All communications in a particular location, for example a chatroom or a room in a virtual reality environment, in which the first user is located may be stored in the first actions log 204. In some virtual reality environments, in which ability to communicate with other users is dependent on virtual distance from those other users, only communications taking place within a predetermined virtual distance of the relevant user may be stored. To enable this, an identifier of the location of the user in the virtual reality environment is stored with each communication by that user, for example using virtual location coordinates. Alternatively, all communications in the online environment may be stored, but rules only applied to those within the predetermined virtual distance.

In embodiments where actions other than linguistic communications are performed by the users and monitored, the first and second actions logs 204, 210 store necessary information to enable the rules to be applied. In a gaming environment, users may be able to move and their locations exposed to other users. In this case, the first and second actions logs 204, 210 may be configured to store location coordinates of users, periodically, for example every second, together with associated time stamps and identifiers of users. With such stored information, a rule can then be configured to detect stalking. By way of other example, the first and second actions logs 204, 210 may be configured to store information relating to the virtual geometry of respective avatars of the users. In this case, one or more rules can be configured to detect sexual contact such as groping in a virtual reality environment. Repeated targeting, for example shooting in some gaming environments, can also be detected, for example by monitoring for repeatedly short lifespans of users and identity of a targeting user. Non-linguistic communications may also include gift giving and financial transactions.

The first actions log 204 stores action information relating to actions relevant to the user of the user device 100 on which the respective first actions log 204 is located, the second actions log 210 stores all action information for the online environment. For example, the first actions log 204 may store action information relating to all actions taking place in a particular location, whereas the second actions log 210 may store action information relating to all actions taking place in all locations in the online environment. Thus first actions log 204 and the second actions log 210 list some of same action information, and the server unit 104 and the user devices are configured to maintain the first actions log 204 synchronised with at least part of the second actions log 210

The first and second actions logs 204, 210 may store other information. For example, where the location is a chatroom and a user inputs an indication, such as by selecting a “reply” button, that he/she is performing a linguistic communication in response to a prior linguistic communication by another user, such that the two communications are connected, the first and second actions logs 204, 210 stores information indicative of this.

In variant embodiments in an online environment in which there is a virtual distance between users, the server unit 104 is preferably configured to provide to each user device 100 information relating to actions by users who are located within a particular virtual distance in the online environment. Thus, while the second actions log 210 stores information relating to all actions taking place in the online environment, the first actions log 204 stores information relating only to actions to which the user may have been subject or exposed.

The rules in the rules data store 206 are intended to detect actions that may be objectionable. The first monitoring module 200 is configured to apply the rules using action information in the first actions log 204 in real-time or close to real-time. The first monitoring module 200 may be configured to apply the rules to actions performed by the user of the device 100, or to actions performed by others, or both.

In alternative embodiments, monitoring for each user device 100 may take place at server unit 104, that is, rules may be applied and a score determined at the server unit 104. It is typically preferred that at least some of the steps are performed at user devices 100 to avoid delay in monitoring and to spread load. However, since the same rules are also stored in the second rules store 212 as at the first rules store, in variant embodiments steps in determining whether an action is objectionable and whether an intervention action should be taken can be performed at the user devices, the server unit 104 or a combination thereof.

Where linguistic communication is monitored, one or more of the rules may be a keyword based rule, in which applying the respective rule comprises looking for the one or more keywords. Keyword based rules may each comprise a list of sub-rules in which particular words, parts of words, combinations of words and/or parts of words are specified, and where existence of such in a communication is a breach of the rule.

One of the more of the rules may each use a trained classifier and the particular rule may be breached dependent on an output of the classifier. The classifier may be a trained natural language classifier, for example. Applying a rule may comprise inputting information relating to the action, which may include symbols, to the classifier, and determining whether the rule is breached based on the output of the classifier. For example, where the action is a linguistic communication, text is input. The classifier may be configured with binary outputs, indicating whether the rule is breached or not. Alternatively, the classifier may be configured to output a probability value, indicative of whether the rule is breached; and the rule may be breached when the probability value exceeds a predetermined threshold value. This probability value may be multiplied, or otherwise combined, with the predetermined rule value to generate a derived rule value for use in determining the score. Such classifiers are trained using historic communications logs where breach of the rule is tagged as having occurred or not occurred.

One or more rules may each comprise a plurality of sub-rules that are each applied to communications. One or more of the sub-rules may use a trained classifier, as described above, or a keyword based rule (which may itself have sub-rules). In variant embodiments of the invention each rule may be otherwise implemented without limitation.

In some embodiment, the rules may evolve for each user, such that each user has rules that are configured for that particular user. For example, where a rule includes a classifier, parameters of the classifier may update based on a response to the question posed to the user to determine the real time comfort value.

In an embodiment, the rules simply comprise a plurality of rules in a list. The first monitoring module 200 is configured to applying the rules to actions using corresponding stored action information to determine whether each of the rules is breached.

In another embodiment, the rules are each assigned to one of several categories, such that each category comprises one or more rules. Embodiments are not limited to any particular categories or way in which categories are organised. In some embodiments, categories may be configured such that they can be turned off by an administrator, such that rules in the categories that are turned off are not applied to new actions.

Categories may correspond to content descriptors used by regulators of online games and software. This way of organising rules enables or helps a game provider to configure monitoring in line with a rating for a game. For example, the Pan European Game Information is a European video game content rating system in which the content descriptors include violence, bad language, fear/horror, sex, gambling, and discrimination. The categories may be configured corresponding to some or all of these descriptors. The Entertainment Software Rating Board (ESRB) assigns age and content ratings in the US and Canada and uses a list of content descriptors to assess ratings. Rules or categories may also correspond to these.

By way of example, a category may be for “bad language”, that is, objectionable language that is offensive or includes swear words. Thus, there are one or more rules in that category intended to trigger a breach when offensive language is used.

By way of another example, in the ESRB system one content descriptor is “strong language”, meaning “explicit and/or frequent use of profanity”, and another is “language”, meaning “mild to moderate use of profanity”. Different rules may be configured in dependence on a degree of severity of offensive words. This category may also have rules for detecting non-verbal, offensive behaviour where such is enabled by the online environment. For example, one or more rules may be provided to detect gestures in a virtual reality environment that may give rise to offence, where the online environment enables avatars to use such gestures.

A category may be provided for “discrimination” and rules relating to racism, homophobia, sexual discrimination, et cetera, may be configured accordingly.

Alternatively, a separate category may be configured is for racism. Rules in that category are intended to detect racist language. A separate category may be configured for homophobia and rules configured for detecting homophobic language and behaviour. Another category may be for detecting terrorist intent. Rules may be configured accordingly.

Another such category may be for begging. For example, a second user may ask the first user or all users in a location for real or virtual currency or goods. One or more rules in the category may be configured to detect begging.

Another such category may be for non-verbal harassment, particularly sexual harassment. Where contact is simulated in the online environment, one or more rules may also be present for sexual assault.

Non-verbal harassment may include stalking. Such stalking may include following of one user by another user from one location in an online environment to another location in the online environment. Stalking may be detected by using location coordinates to determine users within a predetermined distance of the first user have been located within a predetermined distance of the first user for greater than a threshold time, and, additionally or alternatively, whether any user has followed the first user when the first user has moved locations.

Another category may relate to other rules that do not fall into other categories

The particular categories configured in the monitoring system may depend on the particular implementation. Some environments in which the monitoring system may be used may have ratings or labels associated with them, associated with appropriateness of the environment for particular ages. For example, gaming environments may be rated as suitable for all, for people over the age of thirteen, and for people over the age of 18.

One category may simply be for detecting whether users are underage for the environment. The rules in such a category are configured to detect whether the user is under a predetermined age allowed to use the online environment. This might involve detecting communication directly indicating age, or indirectly by detecting communications regarding school, for example.

The category value for sexual harassment is typically high irrespective of a rating or label of the environment.

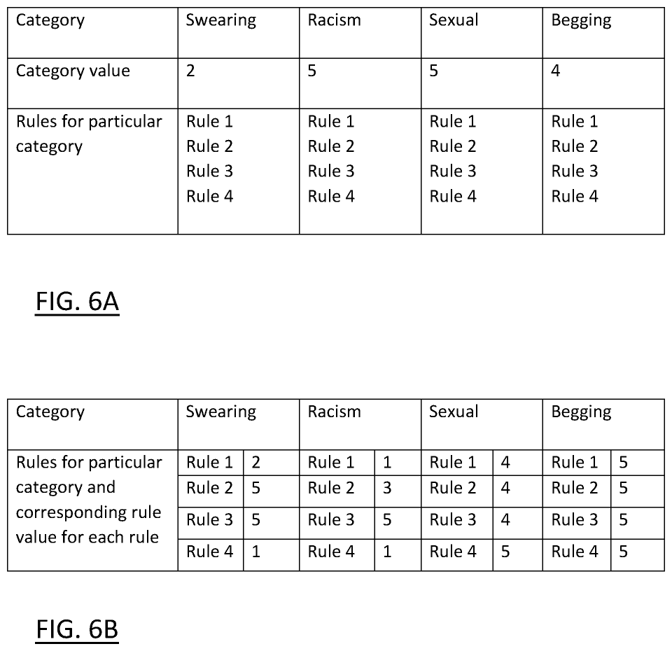

Referring to FIG. 6A, in the embodiment each category has a respective category value associated with it, which, where a rule is breached in that category, is used in determining whether an intervention action should be taken. In the embodiment, the category value is an integer, on a scale from “1” to “5”, where “1” indicates a high tolerance for rule breaches in that category and influences the final determined score to lower the score, and a “5” indicates a low tolerance of such rules breaches and influences the final determined score to raise the score. The category values are preconfigured for the particular environment by an administrator or developer and are not configurable by users, although in alternative embodiments the category values may be configurable by each user to adapt the monitoring system to the respective users needs. In a variant embodiment, the category values may be otherwise configured. Use of categories and category values enables an administrator of the monitoring system to configure the extent to which breach of a rule in a particular category influences the final score and thus intervention.

For example, where the monitoring system is used in a video gaming environment and is labelled as for use only by people over the age of eighteen, the category value relating to bad language may be low since bad language is not considered to necessarily require intervention action when used amongst such people. The category value for bad language may be high where the environment is for use by all people, including children.

Referring to FIG. 6B, in an alternative embodiment, each rule has a rule value associated with it, which, where a rule is breached, is used in determining whether an intervention action should be taken. This is different to the embodiment described with reference to FIG. 6A in that a rule value is configured individually for each rule, rather than for a category. This enables the monitoring system to be configured more specifically such that more appropriate intervention action is taken against users performing objectionable actions.

The rule values may be configured based on seriousness of a breach of the corresponding rule. In this embodiment, the rule value is an integer on a scale from “1” to “5”, where “1” indicates a high tolerance of rule breaches in that category and a “5” indicates a low tolerance of such rules breaches. The rule values are preconfigured for the particular environment by an administrator or developer and is preferably not configurable by users, although in alternative embodiments the rule values may be configurable by each user to adapt the monitoring system to the respective users needs.

By way of example, where the monitoring system is used in a video gaming environment and is designated as for use only by people only over the age of eighteen, the rule value for unacceptable language may be low (“1”) since bad language is not considered to necessarily require intervention action when used amongst people over the age of 18. The rule value for bad language may be high (e.g. “5”) where the environment is for use by all people, including children. In a variant embodiment, the rule values may be otherwise configured.

The rule value for a rule for detecting sexual harassment is typically high irrespective of a rating or label of the environment.

The user data store 208 stores the sensitivity value that the first user wishes the monitoring system to have relating to the first user. This sensitivity value is determined by the first user before beginning communication in the online environment. The sensitivity value may be changed. Alternatively, the sensitivity value may be pre-set at a default value, and be changeable by the user. The sensitivity level may comprise: (1) low, meaning that the first user only wishes to have minimal restriction on the freedom of other users to communicate and behave as they wish in communication with the first user; (2) moderate; (3) strict, meaning that the first user wants a high degree of restriction on freedom of other users to carry out activity that is in breach of any of the rules. Respective sensitivity values corresponding to (1), (2) and (3) are defined in the user data store 208. Sensitivity levels and corresponding values may be otherwise configured.

In some embodiments, the rules are applied to actions by users other than the first user, to which the first user is subject or exposed, to determine if the respective user has breached any rule. However, in preferred embodiments, the rules are applied to actions by the first user. In other embodiments, the rules are applied to both actions to which the first user is subject or exposed, and to actions by the first user.

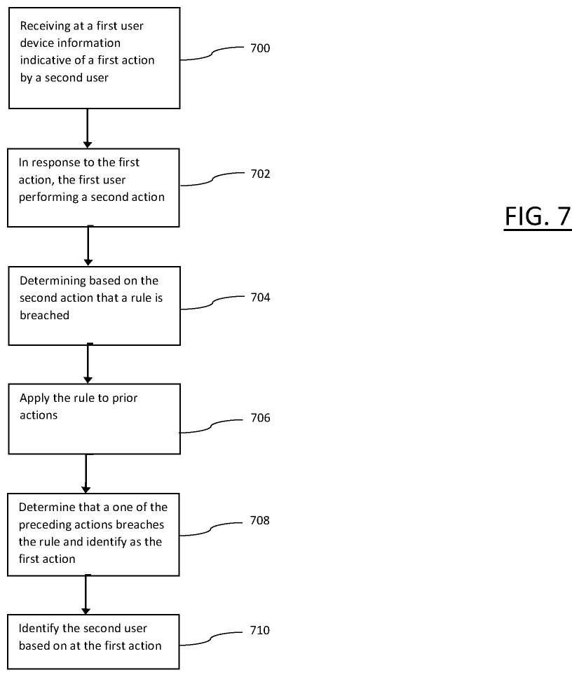

Applying the rules to actions by the first user is advantageous since the rules are breached if an action by a second user is unacceptable subjectively to the first user. For example, the first user may state “go away”, “stop that”, “stop messaging me”, or the like, and such statements breach a rule.

Where there are at least two users other than the first user in a location and each of those other users has performed an action prior to an action by the first user that breaches a rule, it is unclear to which of the other users' actions the action by the first user is a response. This is conventionally problematic, since it is thus not known for which of the other users intervention action should be considered. Steps in the operation of the monitoring system to identify the second user from amongst the other users are now described with reference to FIG. 7. After the second user has been identified, it can then be determined whether intervention action should be taken.

In the following, a “first action” is performed by the second user, who operates the “second user device”, and a “second action” is performed by the first user, who operates the “first user device” in response to the first action.

First, the second user operates the second user device to perform the first action in an online environment. The first user then receives, at step 700, information indicative of the first action at the first user device 100 and corresponding action information is stored in the first actions log 204. For example, where the online environment is a chatroom, the first action may be a linguistic communication that is offensive to the first user. In this case, action information in the form of the communication is stored in the first actions log 204.

At step 702, in response to the first action, the first user performs the second action in the online environment and corresponding action information is stored in the first actions log 204. At step 704, the first monitoring module 200 at the first user device 100 retrieves the rules from the first rules store 206, applies the rules to the second action using the action information for the second action, and determines that the second action breaches one of the rules.

In response to the determining that the second action breaches the rule, the first monitoring module 200 then, at step 706, applies the rules to each action by other users that precedes the second action, using the action information corresponding to each action in the first actions log 204. The monitoring module 200 may be configured to apply the rules only to actions that occurred within a predetermined time period of the second action, using the time stamps associated with each action. Additionally and/or alternatively, the rules may be applied to a maximum number of actions preceding the second action.

The rule that is applied to the preceding actions is the same rule as the rule that was breached by the second action. In a variant embodiment, the rules that are applied to the preceding actions may comprise one or more rules in the category to which the rule that was breached is assigned. The result of this is that the monitoring system does not attempt to locate a first action relating to a different kind of objectionable behaviour than that to which the second action related. In further variant embodiments, different rules are used, that are not used in step 704, and thus the system is configured with one or more rules specifically for the purpose of identifying the first action.

At step 708 the first monitoring module 200 determines that one of the preceding actions breaches one of the applied rules. That action is thus determined to be the first action. At step 710 the first monitoring module 200 then identifies the second user using on the first action, since each action is associated with an identifier of the user who performed it.

A process of determining a score for the second user relating to the breach then takes place. The first monitoring module 200 may do this, or a message may be send to the second monitoring module 202 so that the process can be performed at the server unit 104. Such a message includes an indication of the rule that was breached, together with identifiers of the first and second users, at least.

In a variant embodiment, further to identifying the second user, the first monitoring unit 200 may immediately perform one or more intervention actions against the second user, in order to protect the first user. For example, in an embodiment in which the online environment is a chatroom, communications made in the chatroom by the second user may be blocked relative to the first user, such that there is no display of such communications on the first user device or such communications are rendered unreadable.

In the embodiments described above with reference to FIG. 7, steps 704 to 712 are performed at the first user device 100. However, some or all of steps 704 to 712 may be performed at server unit 104. Thus, the second monitoring module 202 applies the rule, or rules in the same category as the rule, or a designated rule or rule set, to actions to which the first user has been exposed or subject. Where a rule is breached, the second monitoring module 202 then determines the first action that has given rise to the breach, and thus the identity of the corresponding second user.

The monitoring system is configured to determine if intervention action is required in relation to a second user as a consequence of an action by the second user in relation to the first user. If it is determined that an intervention action is required, the intervention action may be performed automatically, or the intervention action may include sending a message to a human moderator.

As mentioned above, whether or not an intervention action is to be taken depends on a determined score, and the score is determined based on values. Processes by which each of the values may be obtained/determined are described.

The sensitivity value for the first user is stored in the first user data store 208. The first monitoring module 200 retrieves the sensitivity value from the first user data store 208.

A respective rule value for each of the rules is stored in the first rules store 206. Accordingly, the first monitoring module 200 retrieves the rule value corresponding to the rule that has been breached by retrieving the rule value from the first rules store 206.

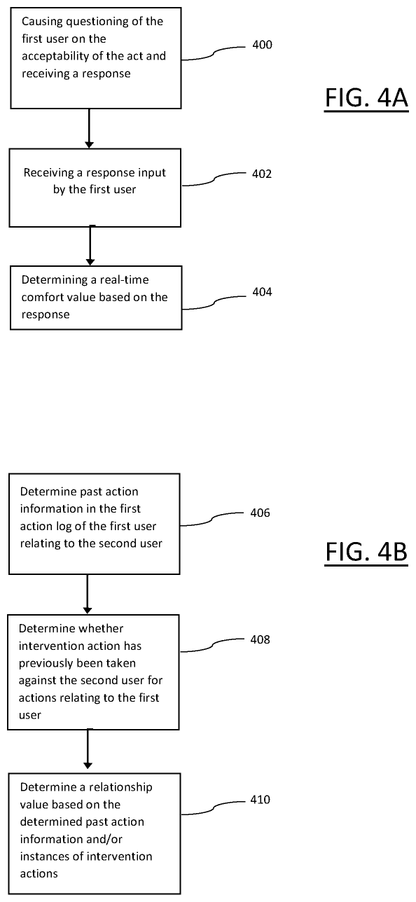

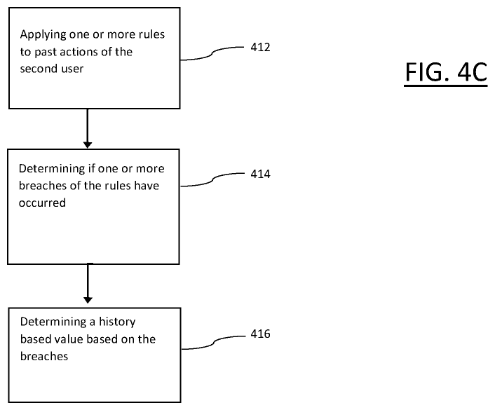

With reference to FIG. 4A, the real-time comfort value is determined by the monitoring module 200 causing at step 400 a question to be asked to the first user on whether the first action by the second user is acceptable to the first user. The question may be posed by a chat box, or an avatar by simulated voice communication, or otherwise. The first user then submits a response at step 402. The first user may select one of a plurality of predetermined responses. For example, the possible responses may be that the first action is acceptable or unacceptable. The possible responses may be that the action raises no issue whatsoever, is on a borderline of acceptability, or is unacceptable. A pre-defined real-time comfort value is associated with each of the possible responses. Alternatively, the first user may respond with a natural language response. In this case, the response is run through a trained classifier, configured to provide the real-time comfort value as an output. At step 404 the real-time comfort value is determined. If the first user does not respond, the degree to which the comfort value influences the final score may be predetermined, and may not influence the final score.

A relationship value is determined for the first user and the second user. The first action log 204 includes past action information relating to the first user in the online environment. Since this first action log also includes action information on actions by other users to which the first user has been exposed, the past action information includes such action information, if any, relating to the second user. Referring to FIG. 4B, at step 406, action information relating to the second user is identified in the first action log 204. For example, this is achieved by the first monitoring module 200 scanning the first user's action log 204 to determine whether the first user and the second user have previously spent time in the same one or more locations in the online environment. Such one or more locations may be one or more chatrooms.

At step 408, the first monitoring unit 200 determines whether any intervention action has been previously taken against the second user in relation to action by the second user relating to the first user. Such information is logged in the user data store of the first user, to facilitate protection of the first user, and is retrieved from there.

A relationship value is then determined at step 410 based on whether the first and second users have spent a proportion of time in the same one or locations that exceeds a predetermined proportion, and based on whether any such intervention action has previously been taken. Other ways of determining the relationship value are possible. For example, whether such an intervention action has previously been taken may not be taken into consideration. By way of other example, where the online environment is a chatroom, it can typically be determined whether one of the first and second user has responded to comments by the other of the first and second users. If this occurs multiple times over spaced time intervals, it indicates that the first and second users are known to each other.

Alternatively or additionally, the relationship value may be determined based on, for example, the number of separate occasions on which the first and second user have been in the same one or more locations (including chatrooms). The relationship value may be determined to influence a final score in favour of taking intervention action in inversely proportional relation to the number of times that the first and second users have been in the same one or more locations. The relationship value be determined to influence a final score in favour of taking intervention action in inversely proportional relation to the number of direct interactions that the first and second users have had. The relationship value may be determined to influence a final score in favour of taking intervention action in inversely proportional relation to the time period (may be years) covering all occasions over which the first and second users have been in the same one or more locations (including chatrooms). In general, the relationship value is configured to reflect influence the final score in inverse proportion to a strength of a relationship between the first and second users, the strength being based on a history of actions in the action log of the first user relating to the second user. The relationship value does not necessarily have to be dependent on actions directly between the first and second user; it may depend on actions by the second user to which the first user was exposed and thus for which there is action information in the action log of the first user.

If the first and second users are known to each other, and no intervention action has previously been taken against the second user, the relationship value functions to influence the final score against taking of an intervention action. If the first and second users are unknown to each other, and/or intervention action has previously been taken against the second user, the relationship value functions to influence the final score in favour of taking of intervention action against the second user.

In a variant embodiment, the relationship value may be usefully generated based on whether actions by the second user relating to the first user have previously breached any rules and, if so, the comfort value generated consequently. Such information is stored in the user data store of the user device 100 of the first user. If the first user has previously indicated that he/she is comfortable with actions performed by the second user that breach rules, a relationship value is generated to influence the score so that intervention action is not taken. As will be appreciated by the skilled person, there are various ways in which the relationship value may be determined and an algorithm in this regard can be configured to process action information on past actions accordingly and other information accordingly.

A history based value for the second user is also determined by the second monitoring module 202. Referring to FIG. 4C, at step 412 one or more rules stored in the second rules store are applied to past actions by the second user, that is, actions preceding the first action. The one or more rules may be the rule that was breached by an action by the first user, or rules in the category to which the breached rule is assigned. Alternatively, all the rules may be applied to each of the second user's actions. At step 414 it is determined if one or more breaches of the one or more rules are determined. At step 416, the history based value is then determined based on the breaches.

The user history based value may be dependent on the number of rules breached. In relation to certain types of behaviour, such as begging, it is common for the second user to beg in multiple locations and/or to multiple people over a short time period. This results in the rule being breached many times, leading to a user history based value that strongly influences the final score to result in intervention action against the second user. Conversely, if the objectionable action relating to the first user is an isolated example of objectionable behaviour by the second user, the determined user history based value functions to have no or little influence over the final score.

The user history based value may be otherwise determined. The user based history based value may be based on stored information on breaches that have already been detected. Information on intervention action that has previously been taken against the second user may also be stored in that user data store. A history based value is then generated based on such information. For example, if the second user has a history of objectionable actions and/or of intervention action being taken against him/her, a history based value that functions to influence the score to cause further intervention action to be taken will be generated. If the second user is determined not to have performed any objectionable actions in the past, a history based value is generated that will influence the score appropriately. The information that is stored on which generation of the user history based value is based may be a number corresponding to each breach, for example the rule value. Alternatively, a counter may simply be incremented. A number may also correspond to each intervention action that have previously been taken against the second user.

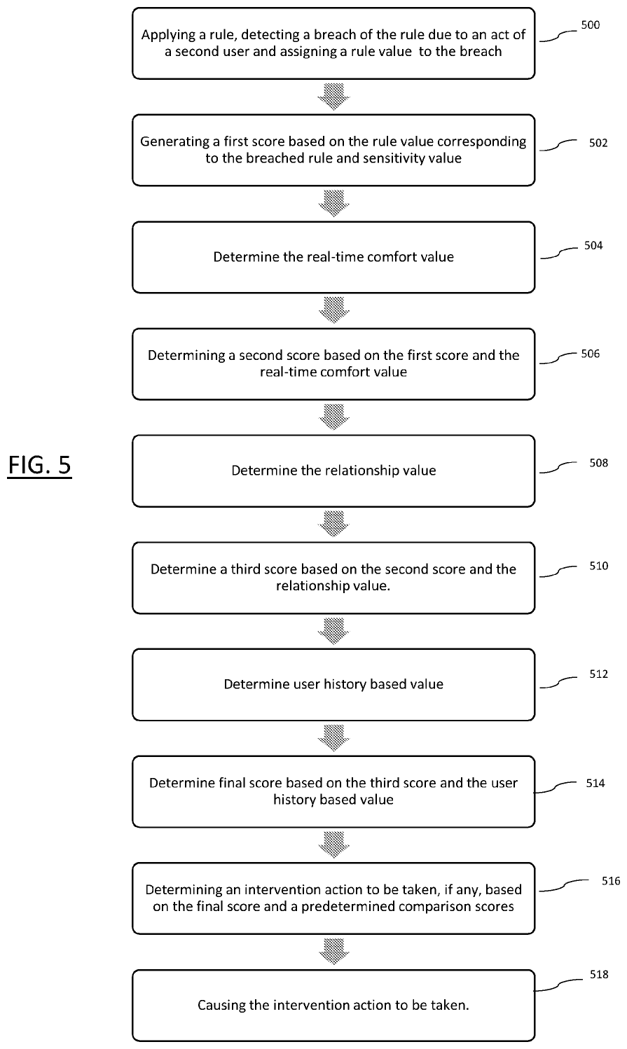

Steps in the operation of the monitoring system are now described with reference to FIG. 5. First, for each new recorded action in the online environment relating to the first user, the first monitoring module 200 checks whether any of the rules have been breached. At step 500, the monitoring module 200 determines that a rule has been breached by an action of the second user. Determining the identity of the second user may be achieved as described above. Determining a breach does not mean the related first action is unacceptable to the first user and that an intervention action is required; the first monitoring module 200 is simply flagging the first action and second user as potentially requiring an intervention action.

The first monitoring module 200 then determines the rule value corresponding to the rule that has been breached by retrieving the rule value associated with the breached rule from the first rules data store 206. The first monitoring module 200 then also retrieves the sensitivity value from the first user data store 208. The first monitoring module 200 then determines a first score based on the sensitivity value and the rule value at step 502.

At step 504, the first monitoring module 200 determines the real-time comfort value. If the user does not respond to the question within a predetermined time, the step of determining the second score may be omitted. Alternatively, the real-time comfort value may be set at a neutral value. At step 506, the first monitoring module 200 determines a second score based on the real-time comfort value and the first score, such that the second score has the same value as the first score.

The first monitoring module 200 determines the relationship value at step 508. At step 510, the first monitoring module 200 determines a third score based on the second score and the relationship value.

A message is then sent to the second monitoring module 204 at the server unit 104. The message includes an identifier of the second user and the third score, and in some embodiments also the identity of the first user and other data. The second monitoring unit 204 then analyses the user history of the second user and determines a user history-based value at step 512. The second monitoring unit 204 then determines a final score based on the third score and the user history-based value at step 514.

The second monitoring module 202 then determines if an intervention action needs to be taken based on the final score and the predetermined comparison scores. If the final score exceeds a first comparison score, a first intervention action may be performed. If the final score exceeds a second comparison score greater than the first score, a second intervention action may be performed. For example, the first intervention action may be simply to send a notification to the second user indicating that actions such as the one detected at step 500 should not be carried out in the online environment. The second intervention action may be to prohibit the second user from using the online environment, and/or may be to escalate to a human moderator. If the third score is less than the first comparison score, no action may be taken.

Where it is determined to take an intervention action that action is then taken. The intervention action may include any one or more of the following, without limitation:
banning the second user from the online environment, temporarily or permanently;
blocking communication between the first and second users;
blocking all visibility and communication between the first and second users;
muting the second user for a predetermined period;
sending a message to an administrator, who may contact law enforcement authorities;
where the environment is an online gaming environment, taking a punitive action in the environment, such as fining virtual currency.

Thus, in the above steps a first score is determined based on the rule value and the sensitivity value, the second score is determined based on the first score and the comfort value, and the third score is determined based on the second score and the relationship value, and the final score is determined based on the third score and the user history based value. The overall effectiveness of the monitoring system is dependent on how the final score is calculated and that the final score is accurate in view of the appropriate intervention action that should be taken when compared against the comparison scores. As will be appreciated, the final score might be calculated directly from the rule value, the sensitivity value, the comfort value and the user history based value. Thus calculation of the first, second and third scores is inessential. Scores do not have to be determined in any particular sequence. Accordingly, the particular functions used to calculate the first, second, third and final scores, or just the final score if intermediary scores are not calculated is relevant. In one embodiment, the values are simply multiplied together, where each value is also multiplied by a predetermined coefficient, which may be “1”. Such coefficients influence the relative importance of each value in determining the final score. Alternatively, the values may comprise exponents in an equation where the final score is dependent on predetermined numbers each to the power of one of the values. Many alternative ways of using the rule value, the user defined value, the comfort value, the relationship value, the user history based value in calculation of a final score are possible.

Further, in embodiments of the invention, not all of the rule value, the relationship value, the sensitivity value, the real-time comfort value, and the user history based value need be used in calculation of a final score. Also, other values may be used in addition.

Information indicative of determines breaches of rules and intervention action taken against the second user is stored in the second user data store 214 at the user device 100 of the second user.

The determining of the score may, generally, be performed at the device 100 of the first user, or at the server unit 104, or at a combination of both. In embodiments in which the user history based value is used to determine the final score, the user history based value would typically require action information located on the server unit 104. Information in the first rules store 206 and the first user data store 208 is reflected in the second rules store 212 and the second user data store 210, enabling steps requiring use of such information to be performed by the second monitoring module 202 as well as by the first monitoring module 200.

Each of the rule value, the sensitivity value, the comfort value, the relationship value, the user history based value in calculation of a final score provide useful information. The comfort value usefully means that the actual view of the first user can be taken into consideration in determining whether intervention action is to be taken. The sensitivity value allows the general sensitivity of the user to be taken into consideration, and also may allow parents to influence sensitivity. The user history based value means that the history of the second user can be taken into consideration. The relationship value usefully means that a relationship between users can be taken into consideration. The values are determined using algorithms stores in the memory unit 108 of the user device of the users, although the values may alternatively be determined at the server.

Different language, that is, different linguistic communications, may be used in different online environments, for example different online gaming environments. Preferably rules are created for each gaming environment in which they are to be used. A rules generation engine is preferably used to create the rules.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

1. A method comprising:
applying, at a processing means, a rule to a user action in an online environment to produce a result, wherein the user action is by a second user and a first user is subject to the user action, or the user action is by the first user in response to a prior action by the second user to which the first user was exposed;
based on the result of the applying:
determining a first value corresponding to the rule;
determining a second value based on past actions in the online environment between the first user and the second user using action information relating to the second user stored in an action log of the first user;
determining a score based at least on first and second values;
determining if at least one intervention action is to be taken against the second user based at least on the score.

2. The method of claim 1, wherein the determining the score is further based on a third value indicative of a sensitivity level set by the first user, as wanted by the first user.

3. The method of claim 1, further comprising:
also based on the result of the applying, causing a question to be posed to the first user;
receiving a response from the first user, wherein a fourth value deriving from the first user is determined based on the response.

4. The method of claim 1, wherein the second value is determined based on whether, when a past action by the second user relating to the first user breached the rule and, further thereto, a question was posed to the first user and a fourth value was generated based on a response being that the first user was comfortable with the user action.

5. The method of claim 1, wherein the rule is one of a plurality of rules, the method further comprising determining the first value corresponding to the rule by retrieving the first value from a data store in which each rule is associated with a respective first value.

6. (canceled)

7. The method of claim 1, further comprising:
determining a fifth value based on actions of the second user in the online environment that precede the user action.

8. The method of claim 7, wherein the determining the fifth value comprises receiving an identifier of the second user at a server means from a user device of the first user, and determining whether, for actions previously performed by the second user, applying a rule has indicated that a score is to be determined.

9. (canceled)

10. The method of claim 1, wherein the determining the second value is based on one or more further results of applying one or more rules to the past actions by the second user that precede the user action.

11. The method of claim 10, wherein the one or more further results are such that a process of determining if at least one intervention action was to be taken is performed.

12. The method of claim 7, wherein the determining the fifth value comprises:
receiving an identifier of the second user at a server means from a user device of the first user, and/or determining an identifier of the second user at the server means;
searching for previous actions performed by second user using the identifier of the second user;
applying one or more of the rules to the actions identified in the searching to generate a one or more further results.

13. (canceled)

14. The method of claim 1, wherein the determining if at least one intervention action is to be taken comprises:
comparing the determined score against one or more threshold scores; and
determining whether the intervention action is to be taken in dependence on a result of the comparison.

15. The method of claim 1, wherein the result of applying each rule indicates whether an objectionable action has occurred.

16. (canceled)

17. The method of claim 1, wherein the user action is a linguistic communication.

18. (canceled)

19. The method of claim 1, wherein the method comprises applying a plurality of the rules to the user action.

20. The method of claim 1, wherein the user action is by the second user, further comprising:
based on the user action, determining the prior action from a plurality of prior actions by at least two users including the second user before the user action;
determining an identifier of the second user based on the determined prior action, wherein the identifier of the second user is used in determining if at least one intervention action is to be taken against the second user.

21. The method of claim 20, wherein the determining the prior action comprises applying one or more rules to the plurality of prior actions and determining the prior action based on a result of applying the rules.

22. The method of claim 1, wherein the online environment is at least one of: a chat room, gaming environment, and a virtual reality environment.

23. (canceled)

24. A non-transient computer readable medium containing a computer program comprising program code which, when executed by a processing means, causes:
applying, at a processing means, a rule to a user action in an online environment to produce a result, wherein the user action is by a second user and a first user is subject to the user action, or the user action is by the first user in response to a prior action by the second user;
based on the result of the applying:
determining a first value corresponding to the rule;
determining a second value based on past actions in the online environment between the first user and the second user using action information relating to the second user stored in an action log of the first user, wherein the action log of the first user includes action information on actions by other users to which the first user has been exposed, wherein the action log of the first user includes action information on actions by other users to which the first user has been exposed;
determining a score based at least on first and second values;
determining if at least one intervention action is to be taken against the second user based at least on the score.

25. Apparatus comprising processing means and memory means having a computer program code stored thereon, wherein the processing means, together with the memory means and the computer program code, are configured to:
apply, at the processing means, a rule to a user action in an online environment to produce a result, wherein the user action is by a second user and a first user is subject to the user action, or the user action is by the first user in response to a prior action by the second user;
based on the result of the applying:
determine a first value corresponding to the rule,
determine a second value based on past actions in the online environment between the first user and the second user using action information relating to the second user stored in an action log of the first user,
determine a score based at least on first and second values;
determine if at least one intervention action is to be taken against the second user based at least on the score.

26. (canceled)

27. The method of claim 1, wherein, if the first and second users are known to each other based on past actions, and no intervention action has previously been taken against the second user, the second value functions to influence the score against taking of an intervention action, and
wherein, if the first and second users are unknown to each other, and/or intervention action has previously been taken against the second user, the second value functions to influence the score in favor of taking of intervention action against the second user.
